(19) United States
(12) Patent Application Publication
(10) Pub. No.: US 2026/0266233 A1
(43) Pub. Date: Sep. 10, 2026

(54) Engine Control System

(71) Applicant: JCB Research, Uttoxeter (GB)

(72) Inventors: Divyesh Patel, Uttoxeter (GB); Anthony Jeffery, Uttoxeter (GB)

(21) Appl. No.: 19/164,195

(22) PCT Filed: Mar. 8, 2024
(86) PCT No.: PCT/GB2024/050629

§ 371 Date: Sep. 10, 2025

(30) Foreign Application Priority Data
Mar. 10, 2023 (GB) 2302547.0

(51) Int. Cl. F02D 41/04; F02D 41/00; F02P 5/04

(52) U.S. Cl. CPC F02D 41/042; F02D 41/0027; F02P 5/045

(57) ABSTRACT

An engine shutdown system for a hydrogen fueled internal combustion engine, the system including a controller; wherein upon receipt of a standard engine shutdown command, the controller is configured to instruct the clearing of excess hydrogen fuel from a fuel delivery system of the engine as part of an engine shutdown process.

### FIELD

The present teachings relate to an engine control system. In particular, the present teachings relate to an engine start system for a hydrogen fueled internal combustion engine. In addition, the present teachings relate to an engine shutdown system and a method of operating/starting and/or shutting down a hydrogen fueled internal combustion engine.

### BACKGROUND

In modern internal combustion (IC) engines, fuel is injected directly or indirectly into each combustion chamber by a fuel injector. Upstream of the fuel injector is a common fuel rail which distributes the fuel to each injector under pressure.

In order to reduce emissions from internal combustion engines, as well as potentially to reduce greenhouse gases, hydrogen is being proposed as an alternative to diesel or gasoline as a fuel for such engines.

Due to the intrinsic properties of hydrogen, it has been found, in some circumstances, to leak over time from the fuel rail past the injectors into the intake system and/or cylinders of IC engines. At the operating pressures within the common fuel rail, and given its compressible nature, a large volume of hydrogen can therefore dwell within these areas of the engine.

When the engine is subsequently re-started, there is therefore a risk of this hydrogen causing a thermal or backfire event which may cause damage to engine components, which is clearly undesirable. There is also a risk of the hydrogen escaping into the environment, which is also undesirable, as in its uncombusted form, it is itself a greenhouse gas.

Further, the primary product of hydrogen combustion in an IC engine is water. There is believed to be an elevated risk of water fouling of spark plugs used in hydrogen fueled IC engines. This may prevent combustion of hydrogen in one or more cylinders of an engine, which may prevent the engine operating entirely, or only running on a reduced number of cylinders. In the latter case, this may result in undesirable hydrogen emissions, compromised engine power output, and/or damage to engine components.

The present teachings seek to overcome or at least mitigate the problems of the prior art.

### SUMMARY

A first aspect of the teachings provides an engine shutdown system for a hydrogen fueled internal combustion engine. The system may comprise a controller. Upon receipt of a standard engine shutdown command, the controller may be configured to instruct the clearing of excess hydrogen fuel from a fuel delivery system of the engine as part of an engine shutdown process.

Advantageously, this arrangement ensures that fuel which may otherwise have leaked from the fuel delivery system into the engine intake system and/or cylinder is at least partially purged, thereby reducing the risk of a backfire event or other anomaly upon subsequent re-start of the engine.

Optionally, the system further comprises: at least one fuel ignition device in communication with the controller; a fuel delivery system in communication with the controller; wherein the system is configured such that upon receipt of an engine shutdown command. The controller is optionally configured to instruct the ceasing of the supply of hydrogen fuel into the fuel delivery system and/or is optionally configured to allow extended operation of the engine beyond the ceasing of the supply of hydrogen so as to clear excess hydrogen held within the fuel delivery system by combustion.

Advantageously, by combusting the fuel, unburnt hydrogen is not emitted to atmosphere.

Optionally, the controller is configured to instruct an increase of the ratio of fuel to air/lambda during the extended operation of the engine.

This enables more rapid use of fuel during the extended operation and therefore enables it to be completed more quickly before actual shutdown of the engine, reducing operator inconvenience.

The ratio of fuel to air may be conventionally referred to as an air fuel equivalence ratio (i.e., lambda). Lambda may have its conventional meaning of air-fuel ratio/stoichiometric air fuel ratio (which is 34:1 for hydrogen). Optionally, lambda may be reduced to between 1.1 and 1.7, preferably between 1.2 and 1.6, more preferably between 1.3 and 1.5 during the extended operation of the engine. Lambda prior to engine shut down may be between 1.8 and 4.5.

The reduction in lambda may be provided by increasing the duration the injector is open. The duration the injector is open may be between 6 ms and 35 ms. The duration of the injector being open may be dependent on the rail pressure as the pressure reduces and in accordance with a predetermined relationship. The predetermined relationship may be dependent on the expected or measured rail pressure and the duration required to maintain the air fuel ratio.

The engine timing may be adjusted during the extended operation period, so as to reduce the torque. Optionally, the engine timing, that is, the time of the sparking of the ignition device, may be between +10 degs or −20degs in relation to top dead center. For avoidance of doubt, −20 degs refers to −20 degrees before top dead center, +10 degrees refers to after top dead center. The spark timing may be between 0 and −2 degrees, effectively top dead center after shut down.

The engine shutdown system may further comprise a first plurality of engine maps used prior to the engine shut down command and a second plurality of engine maps used for the extended operation after the engine shut down command. The engine maps may be used to determine the required ignition spark timing and injection time for each cylinder.

If the engine comprises more than one cylinder, the ratio may not be increased on all cylinders.

Optionally, the system comprises a plurality of fuel ignition devices corresponding to a plurality of engine cylinders and wherein the controller is configured to instruct ceasing of the sparking of one of the fuel ignition devices for at least part of the extended operation of the engine.

This may minimize the risk of rich running of the engine causing a wetting of at least one of the fuel ignition devices, meaning there is a reduced risk of engine re-start being compromised.

Optionally, the controller permits operation for a pre-determined period or for a predetermined number of engine revolutions.

Advantageously, this is a way of ensuring that the operation is predictable on the part of the operator.

Optionally, the controller monitors a fuel pressure in the fuel delivery system and permits operation until a predetermined pressure of the fuel is reached.

By monitoring pressure a finer control of the purge operation may be achievable. In addition, if the predetermined pressure is above ambient pressure this may inhibit debris from entering the fuel delivery system and impairing its operation.

Optionally, the controller is configured to log in a memory once the clearing operation is completed.

Such a log may enable a subsequent re-start strategy to be altered e.g., if the engine stalls or an emergency stop is actuated rather than a standard shutdown.

Optionally, the fuel delivery system comprises a fuel injector in fluid communication with a common fuel rail and the controller instructs a closing of a supply of fuel upstream of the common fuel rail during the extended operation.

This allows the common fuel rail to be emptied of fuel to a required degree prior to shutdown which may be advantageous because the fuel is held therein under high pressure so can otherwise as a significant reservoir for fuel that may escape to atmosphere or into parts of the engine where it may present a backfire/thermal event risk if left for an extended period.

Optionally, the at least one fuel ignition device comprises an ignition coil and a spark plug.

A second aspect of the teachings provides a method of shutting down a hydrogen fueled internal combustion engine comprising at least one fuel ignition device and a hydrogen fuel delivery system, the method comprising the steps of:
a. upon receipt of an engine shutdown command instructing the ceasing of the supply of hydrogen into the fuel delivery system and
b. allowing the extended operation of the engine beyond the ceasing of the supply of hydrogen so as to combust hydrogen held within the fuel delivery system.

Optionally, the method comprises a further step c) of instructing an increase of the ratio of hydrogen to air during the extended operation of the engine.

Optionally, the system comprises a plurality of fuel ignition devices corresponding to a plurality of engine cylinders and wherein the method comprises the further step d) of instructing ceasing of the sparking of one of the fuel ignition devices for at least part of the extended operation of the engine.

Optionally, the method comprises a further step e) of logging in a memory the completion of the extended operation.

Optionally, the fuel delivery system comprises a fuel injector in fluid communication with a common fuel rail and the method comprises a further step f) of closing of a supply of fuel upstream of the common fuel rail during the extended operation.

A third aspect of the teachings provides an engine control system for a hydrogen fueled internal combustion engine, the system comprising a controller; wherein, the controller is configured to confirm if excess hydrogen has been cleared from the engine prior to a start of the engine, and if clearing of excess hydrogen cannot be confirmed, the controller is configured to instruct a hydrogen purge operation of the engine prior to permitting a restart of the engine.

Advantageously, this arrangement ensures that fuel which may otherwise have leaked from the fuel delivery system into the engine intake system and/or cylinder is exhausted, thereby reducing the risk of a backfire event or other anomaly upon subsequent re-start of the engine.

Optionally, upon receipt of a standard engine shutdown command, the controller is configured to instruct the clearing of excess hydrogen from a fuel delivery system of the engine as part of an engine shutdown process.

It is typically less disruptive to normal machine operation if clearing can be achieved at shutdown, rather than delaying start up.

Optionally, at least one fuel ignition device may be in communication with the controller; and a hydrogen fuel delivery system may be in communication with the controller.

The system may be configured such that upon receipt of an engine shutdown command the controller may be configured to instruct the ceasing of the supply of fuel into the fuel delivery system and may also be configured to allow an extended operation of the engine beyond the ceasing of the supply of fuel so as to combust fuel held within the fuel delivery system.

It may be advantageous to clear excess hydrogen at shutdown, if possible, since it can then be safely combusted, rather than vented to atmosphere.

Optionally, the controller is configured to instruct an increase of the ratio of fuel to air during the extended operation of the engine.

Optionally, the system comprises a plurality of fuel ignition devices corresponding to a plurality of engine cylinders and wherein the controller is configured to instruct ceasing of the sparking of one of the fuel ignition devices for at least part of the extended operation of the engine.

Optionally, the controller is configured to log in a memory once extended operation is completed.

Optionally, the fuel delivery system comprises a fuel injector in fluid communication with a common fuel rail and the controller instructs a closing of a supply of fuel upstream of the common fuel rail during the extended operation.

Optionally, the controller is configured to instruct the cranking of the engine without instructing the sparking of the fuel ignition device so as to purge the engine of hydrogen prior to permitting a start of the engine.

Optionally, the controller is further configured to instruct the hydrogen fuel delivery system not to supply fuel during the purge operation.

Optionally, the controller is configured to instruct the purge operation for a predetermined time

Optionally, the controller is further configured to instruct sparking of the fuel ignition device without instructing the supply of fuel to commence and is optionally configured to monitor an output of the fuel ignition device for a signal indicative of the generation of a spark prior to permitting a start of the engine.

The sparking may typically be undertaken a plurality of times. In some systems sparking may only be possible in combination with cranking of the engine in accordance with a normal engine cycle, but in other systems may be untaken independently of cranking, and may therefore be possible at a greater frequency.

A fourth aspect of the present teachings provides hydrogen fueled internal combustion engine comprising an engine shutdown system according to the first aspect and/or an engine control system according to the third aspect of the present teachings.

A fifth aspect of the present teachings provides a working machine comprising a hydrogen fueled internal combustion engine according to the fourth aspect.

A sixth aspect of the teachings provides a method of controlling a hydrogen fueled internal combustion engine, the method comprising the steps of
a. confirming if excess hydrogen has been cleared prior to a restart of the engine, and
b. if clearing of excess hydrogen cannot be confirmed, to optionally instruct a hydrogen purge operation of the engine prior to permitting a restart of the engine.

Optionally, the method comprises the further step c) wherein upon receipt of a standard engine shutdown command of clearing of excess hydrogen from the engine as part of an engine shutdown process.

A seventh aspect of the teachings provides an engine start system for a hydrogen fueled internal combustion engine. The system may comprise a controller; at least one fuel ignition device in communication with the controller; and/or a hydrogen fuel delivery system in communication with the controller. The system may be configured such that upon receipt of an engine start command, the controller is configured to instruct sparking of the fuel ignition device without instructing the supply of fuel to commence and may also be configured to monitor an output of the fuel ignition device for a signal indicative of the generation of a spark.

Advantageously, this arrangement prevents uncombusted hydrogen being expelled from the engine due to the absence of a spark in the cylinder of the engine to cause combustion. The venting of uncombusted hydrogen is undesirable from a safety and from an environmental perspective.

Optionally, upon detection of a spark the controller is configured to instructing supply of fuel for combustion in the engine.

Advantageously, once a spark is detected it is then appropriate to supply the fuel as it will be combusted rather than being expelled to atmosphere.

Optionally, the controller is further configured to determine whether the fuel delivery system of the internal combustion engine is cleared of excess hydrogen prior to instructing the sparking of the at least one fuel ignition device.

Advantageously, this ensures that the controller can avoid carrying out the sparking if there is a risk of hydrogen already in an engine being combusted in an uncontrolled manner which may damage the engine.

Optionally, the controller is further configured to instruct a drying operation of the at least one fuel ignition device upon determining that sparking of the fuel ignition device is not successful.

Advantageously, this may enable the engine to run normally without requiring a specific service operation.

Optionally, the fuel ignition device drying operation, the controller signals the sparking of the or each fuel ignition device which is determined to be wet.

Advantageously, the sparking operation promotes the drying of the ignition devices by the flow of a current therethrough.

The sparking may typically be undertaken a plurality of times. In some systems sparking may only be possible in combination with cranking of the engine in accordance with a normal engine cycle, but in other systems may be untaken independently of cranking, and may therefore be possible at a greater frequency.

Optionally, the fuel ignition device drying operation comprises a cranking of the engine without the supply of fuel.

Advantageously, cranking of the engine promotes a flow of air past the fuel ignition device, promoting a drying thereof.

Optionally, during the drying operation the controller is configured to monitor the output of the fuel ignition device for a signal indicative of the generation of a spark.

Such a signal is indicative of the drying operation being successful.

Optionally, in the event of a signal indicative of the generation of a spark being detected, the controller is configured to instruct the ceasing of the drying operation and to instruct the supply of fuel to an engine cylinder corresponding to the fuel ignition device.

Advantageously this allows the delay to starting the engine to be minimized if the fuel ignition device is dry.

Optionally, the controller is configured subsequent to instructing the supply of fuel to monitor for combustion of the fuel in the cylinder.

Although a dry fuel ignition device is likely to result in combustion, it is advantageous to check that combustion does result, to avoid unburnt hydrogen being exhausted to the engine surroundings.

Optionally, the controller is configured to instruct ceasing to supply fuel to the cylinder and to instruct the generation of a spark for that cylinder in the event that no combustion is detected.

Advantageously, this allows another opportunity for drying to take place, in particular if other cylinders are combusting fuel, the engine may run on fewer than all cylinders and those not running may be allowed another opportunity to dry.

Optionally, the controller is configured to instruct the supply of fuel to the cylinder in the event that a spark for that cylinder is detected.

Advantageously, this allows the normal running of the engine to be seamlessly achieved once the relevant fuel ignition device is dry.

Optionally, the controller is configured to determine if the engine is cleared of excess hydrogen by confirming if a previous normal engine shutdown procedure was completed.

It is advantageous for hydrogen to be cleared prior to engine shutdown, so as not to delay the following engine start.

Optionally, the controller is configured to instruct a hydrogen purge operation in the event that the internal combustion engine is determined not to be clear of excess hydrogen.

If there is the possibility of excess hydrogen it is desirable for safety reasons that it is cleared prior to testing the sparking, since a backfire event may otherwise occur.

Optionally, the controller is configured to instruct the cranking of the engine without instructing the sparking of the fuel ignition device so as to purge the engine of hydrogen.

Advantageously this is an effective way of clearing hydrogen without requiring additional engine hardware.

Optionally, the controller is further configured to instruct the hydrogen fuel delivery system not to supply fuel during the purge operation.

To minimize the volume of hydrogen to be cleared it is desirable not to purge any hydrogen that remains upstream of the hydrogen fuel delivery system.

Optionally, the controller is configured to instruct the purge operation for a predetermined time or for a predetermined number of engine revolutions.

Advantageously these are effective methods of determining when a finite volume of hydrogen in the engine will be cleared.

Optionally, the at least one fuel ignition device comprises an ignition coil and a spark plug.

Optionally, the hydrogen fuel delivery system comprises at least one fuel injector optionally in fluid flow communication with a common fuel rail.

Optionally, the engine comprises a plurality of cylinders.

Optionally, the controller is configured to instruct ceasing the drying operation only in the event of a signal indicative of the generation of a spark being detected in fuel ignition devices corresponding to each of the plurality of cylinders.

It is desirable that a complete drying of all fuel ignition devices is achieved for a successful subsequent engine start.

The features of the seventh aspect may also be combined with the features of the first, second, third, further, fifth or sixth aspects.

An eighth aspect of the teachings provides a hydrogen fueled internal combustion engine comprising an engine start system according to the seventh aspect of the present teachings.

A ninth aspect of the present teachings provides a working machine comprising an engine according to the eighth aspect of the present teachings.

A tenth aspect of the teachings provides a method of starting a hydrogen fueled internal combustion engine comprising at least one fuel ignition device and a hydrogen fuel delivery system, the method comprising the steps of:
a. upon receipt of an engine start command, instructing sparking of the fuel ignition device without instructing the supply of fuel to commence;
b. monitoring an output of the fuel ignition device for a signal indicative of the generation of a spark.

Optionally, the method further comprises a step c) after step b) of upon detecting a spark, instructing supply of hydrogen fuel for combustion in the engine.

Optionally, the method further comprises a step d) after step b) of undertaking drying operation of the at least one fuel ignition device upon determining that sparking of the fuel ignition device is not successful.

Optionally, the method further comprises a step e) of determining whether the fuel delivery system of the internal combustion engine is cleared of excess hydrogen prior to instructing the sparking of the at least one fuel ignition device.

The features of the tenth aspect may also be combined with the features of the first, second, third, further, fifth or sixth aspects.

### BRIEF DESCRIPTION OF DRAWINGS

Embodiments are now disclosed by way of example only with reference to the drawings, in which:

FIG. 1 is a schematic plan view of an internal combustion engine and control system according to an embodiment of the present teachings;

FIG. 2 is a cross-sectional view of the internal combustion engine shown in FIG. 1 vertically through the cylinder head, showing inlet and outlet systems;

FIG. 3 is a flow chart of an engine start process according to an embodiment of the present teachings;

FIG. 4 is a flow chart of an engine shutdown process according to an embodiment of the present teachings; and

FIG. 5 is a side view of an exemplary working machine incorporating an internal combustion engine of FIG. 1.

### DETAILED DESCRIPTION

In the following detailed description, numerous specific details are set forth in order to provide a thorough understanding of various embodiments and the inventive concept. However, those skilled in the art will understand that: the present teachings may be practiced without these specific details or with known equivalents of these specific details; that the present teachings is not limited to the described embodiments; and, that the present teachings may be practiced in a variety of alternative embodiments. It will also be appreciated that well known methods, procedures, components, and systems may not have been described in detail.

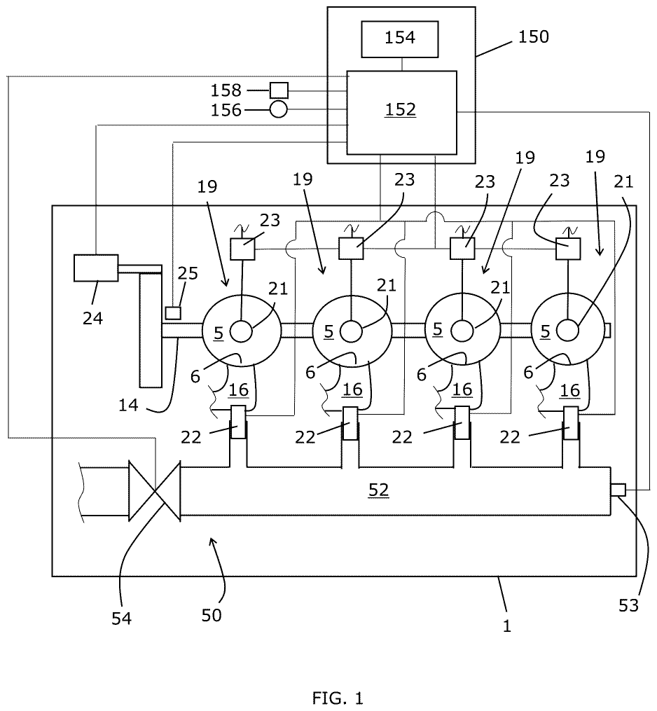

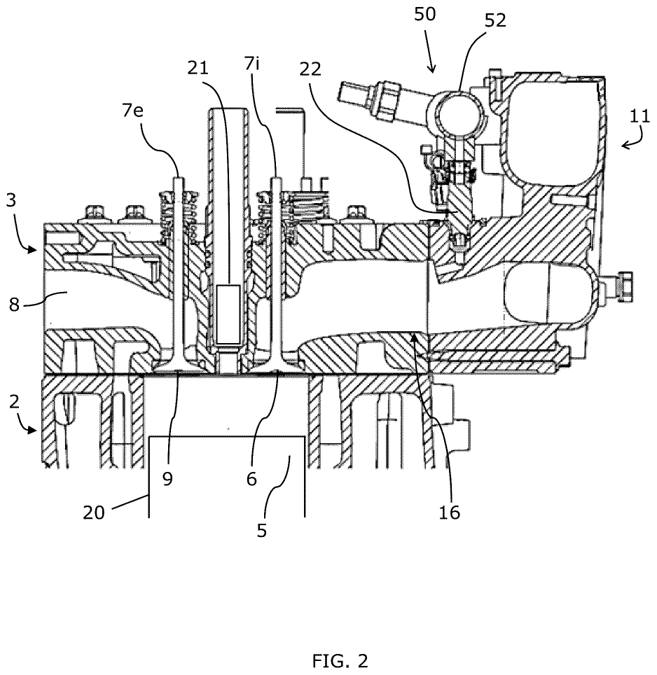

Referring firstly to FIGS. 1 and 2, an embodiment includes an internal combustion engine 1. FIG. 1 shows a schematic plan view of the engine 1, and FIG. 2 shows a vertical cross-section of a cylinder and cylinder head of the engine of FIG. 1.

The engine 1 is a four-stroke gaseous fuel IC engine configured to be powered by hydrogen.

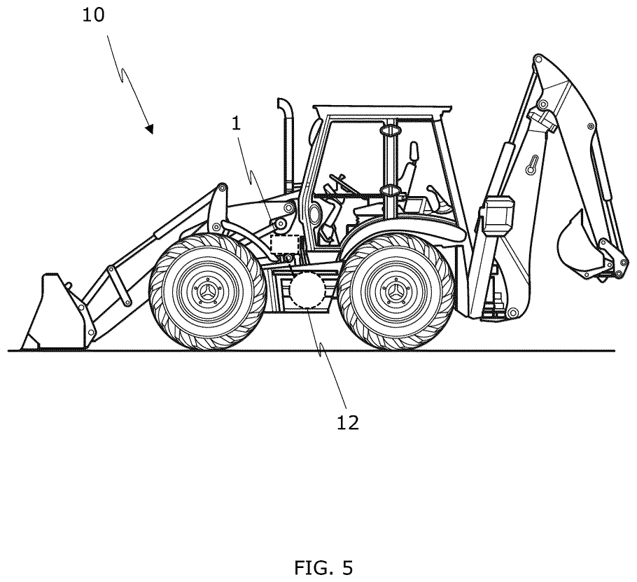

The engine 1 may be suitable for use as the prime mover in a working machine 10 see FIG. 5 which depicts a backhoe loader, but may also be a telescopic handler, a forklift truck, a wheeled loading shovel, a dumper, an excavator or a tractor, for example. Such working machines 10 are suitable for use in off-highway applications such as agriculture, forestry and construction. In these industries they are generally configured to perform tasks such as excavation, load handling, harvesting or planting crops. The engine 1 may also be utilized in a genset—a self-contained unit to provide electrical power at off-grid locations. As such the engine 1 is typically required to have certain characteristics such as a high torque output over a wide engine speed band, with peak torque occurring at a relatively low engine speed. which differ from light passenger vehicles, for example. In off-highway applications, this provides “torque backup” that enables working machines 10 to continue to carry out working operations when encountering increased loads, or resistance to a working operation—e.g., an excavator encountering a particularly solid piece of earth to be excavated.

In this embodiment, the engine 1 has four cylinder assemblies indicated generally at 19. As configured the engine has a maximum power output of around 55 KW, although it will be appreciated that the present teachings are applicable to engines with a wide range of power outputs. In the present embodiment the engine has a total displacement of 4.4 liters (i.e., 1.1 liters per cylinder). In engines used in off-highway applications each cylinder may typically have a displacement of between 0.75 and 1.5 liters. Such a displacement is relatively high by comparison with passenger vehicle engines, but is suited to providing the operating characteristics described above.

In this embodiment the engine 1 is fueled solely by hydrogen. In other embodiments, the engine 1 may be fueled by hydrogen in combination with other fuels, such as natural gas.

Each cylinder assembly 19 includes a cylinder 5 including a bifurcated inlet port 6 (a single one visible for clarity) and a bifurcated outlet port 9 (visible in FIG. 2 only), a piston 20 translationally movable within the cylinder 5, an intake runner 16 leading from an intake manifold 11 to the inlet port 6, and a fuel injector 22.

Each cylinder assembly 19 is configured to selectively inject a gaseous hydrogen fuel from the fuel injector 22 into the intake runner 16.

Each inlet port 6 is selectively opened and closed by intake valves 7i, (one visible, but two intake valves 7i per cylinder 5). Each outlet port 9 is selectively opened and closed by two exhaust valves 7e (one visible in FIG. 2) per cylinder 5.

The engine 1 is configured to supply gaseous hydrogen fuel and air from the intake runner 16 to the cylinder 5 via the inlet port 6 during an intake stroke of the piston 20, and exhaust combustion gases from the cylinder 5 via the outlet port 9 during an exhaust stroke of the piston 20.

In alternative embodiments (not shown), the engine 1 may have more or fewer cylinder assemblies 19, e.g., 2, 3, 6, or 8. In addition, in other embodiments the cylinders 5 may be oriented in a “V” or boxer configuration rather than inline as in the disclosed embodiment.

The engine 1 comprises a cylinder block 2 and a cylinder head 3. The cylinder block 2 includes the cylinders 5. The cylinder head 3 includes at least a part of the intake runner 16 of each cylinder assembly 19.

The cylinder head 3 is mounted to the cylinder block 2. The intake manifold 11 is mounted to the cylinder head 3. The engine 1 is configured such that the intake runners 16 supply a mixture of air from the intake manifold 11 and fuel from the injectors 22 to the corresponding cylinders 5 of the cylinder block 2 via the inlet port 6. As such, the engine 1 is a port fuel injection engine (i.e., fuel is provided to the cylinders 5 via port fuel injection).

In other embodiments the engine may instead be direct injection—i.e., hydrogen fuel is injected directly into each cylinder via injectors located at the roof of each cylinder.

In the illustrated embodiment, a fuel delivery system 50 comprising a fuel injector 22 in fluid communication with a common fuel rail 52 is supplied with gaseous hydrogen fuel from a fuel tank 12 (FIG. 5). The supply can be isolated by a fuel supply valve 54 at an upstream end of the common fuel rail 52.

As the engine 1 utilizes hydrogen as fuel, a spark is required to initiate combustion. Thus, each cylinder assembly 19 comprises a spark plug 21 (illustrated schematically) mounted intermediate the inlet and outlet ports 6, 9 in the cylinder head 3. The spark plugs 21 are connected to respective coils 23 which generate a high tension current to initiate the spark in the spark plug, as required, during the combustion cycle of the engine 1. Each spark plug 21 and respective coil 23 is collectively referred to as a fuel ignition device.

The engine 1 includes a crankshaft 14 coupled to each piston 20. The engine 1 is configured such that translational movements of each piston 20 is converted into rotational movement of the crankshaft 14 around a rotational axis thereof. Rotation of the crankshaft 14 drives a camshaft (not shown), which moves the intake valves 7i and the exhaust valves 7e between open and closed positions. An electric starter motor 24 is provided to turn the crankshaft 14 and start the engine 1.

With reference to FIG. 1, the engine 1 includes a controller 150 configured to control the operation of the engine 1. The controller 150 may be an engine control unit (ECU).

The controller 150 may comprise any suitable circuitry to achieve control of the engine 1 and follow the control methods described herein. The controller may comprise: control circuitry; and/or processor circuitry; and/or at least one application specific integrated circuit (ASIC); and/or at least one field programmable gate array (FPGA); and/or single or multi-processor architectures; and/or sequential/parallel architectures; and/or at least one programmable logic controllers (PLCs); and/or at least one microprocessor; and/or at least one microcontroller; and/or a central processing unit (CPU), to perform the described methods. The controller 150 comprises in this embodiment a microprocessor 152 and an associated memory 152. The memory 152 may be a non-volatile flash memory.

As part of its control function the controller 150 communicates with the fuel injectors 22, coils 23, the starter motor 24 and the fuel supply valve 54. The controller 150 monitors rotation of the crankshaft 14 via a crankshaft sensor 25, and may monitor fuel pressure in the common fuel rail 52 via a pressure sensor 53. In addition, the controller 150 receives inputs from an engine start device 156 such as a key, button, and/or touchscreen operable by a machine operator and also outputs status information to a visual and/or audible output 158, such as a lamp, buzzer and/or multifunction display—e.g., on a dashboard in a cabin, or on an operator panel. It will be appreciated that whilst these signal connections are depicted in FIG. 1 as being direct links, they may in fact be provided via intermediate controllers controlling other parts of an overall machine, such as a controller for the fuel supply (not shown). In addition the communication may in some instances be via a network connection, such as a CAN bus.

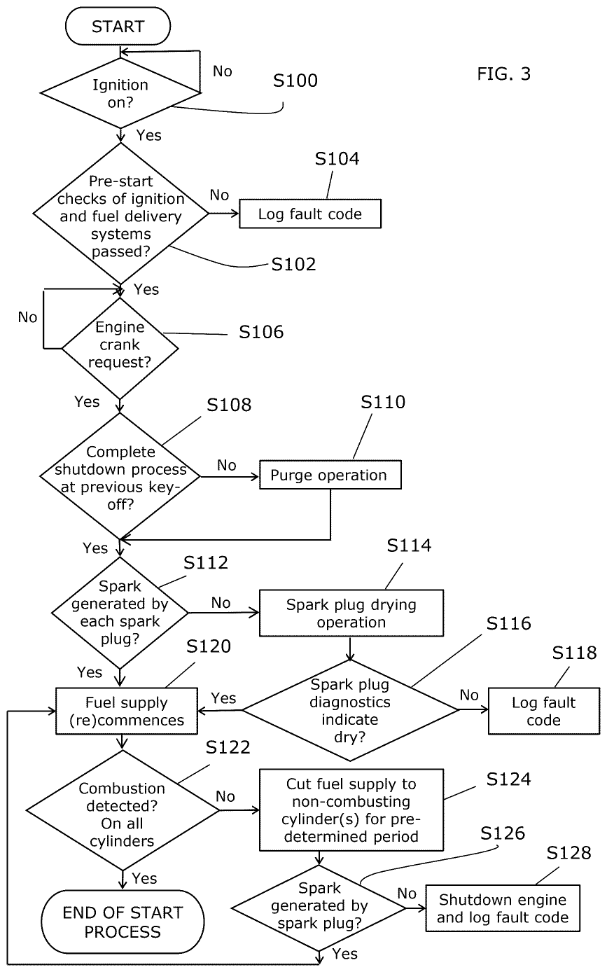

With reference to FIG. 3 an engine start process according to an embodiment is now described.

At step S100 the process commences when the start device 156 of the engine 1 Is turned on to a first condition at which the engine electrical systems including the controller 150 are activated. At step S102, the controller 150 carries out pre-start checks not forming part of the present teachings to confirm the engine 1 is able to start, and if not outputs a fault code at step S104 and prevents engine start.

If the checks at step S102 are passed, the controller 150 then monitors for an engine crank request at step S106—e.g., the operator placing the engine start device 156 into a second condition to demand cranking of the engine 1.

At step S108, the controller interrogates the memory 154 for a flag indicating that a previous engine shutdown process (described in more detail below) has been completed. If the flag indicates the process was not completed, due to an engine stall or emergency shutdown, for example, the controller 150 signals for a purge operation of the engine to be undertaken at step S110.

An emergency shutdown may occur when an operator shuts off the engine via an isolator switch (not shown), rather than using the engine start device 156. Such isolator switches are a legislative requirement on working machines to isolate the machine electrics for safety during maintenance, but are sometimes used by operators as a “shortcut” means of stopping an engine from outside the cab. An emergency shutdown may also occur if an engine or aftertreatment fault detected by the controller 125 necessitates an immediate shutdown.

In a purge operation, the controller signals the starter motor 24 to crank the engine 1 without signaling the firing of the coils 23 to initiate a spark in the spark plugs 21, as well as to open a throttle valve (not shown) in the air inlet path, at least partially, to facilitate airflow. It has been observed that, in some circumstances, hydrogen held under pressure (approx. 10 bar) in the common fuel rail 52 can leak past the fuel injector 22 nozzles and then collect in the cylinders 5, intake runners 16 and/or intake manifold 11. This purge operation flushes out unburnt hydrogen from these locations, which is desirable as it minimizes the risk of a thermal event/backfire event outside the cylinder that may damage components of the engine 1 if the engine were to start with this excess hydrogen.

In this embodiment, the controller 150 signals the purge operation to run for a predetermined time, that is calculated as being sufficient to displace the volume of hydrogen that is held within the common fuel rail 52 at its operating pressure when expanded to atmospheric pressure, the displacement of the engine 1 and the volume of the air induction system. Typically this may equate to a time of approximately 1-3 seconds. In other embodiments, the controller may instead signal the purge operation to run for a predetermined number of crank revolutions. The crankshaft sensor 25 associated with the crankshaft 14 may be used by the controller 150 to monitor the number of revolutions, for example.

In this embodiment, the injectors 22 are not opened during the purge operation, so that any hydrogen still held within the common fuel rail 52 is retained. In other embodiments the injectors 22 are opened (but with the fuel supply valve 54 closed) to also purge the common fuel rail 52. In this embodiment the controller 150 may monitor the fuel rail pressure via the pressure sensor 53. The pressure having reached a pressure around atmospheric pressure may be taken as an indication of the purge operation being completed.

To indicate to an operator that the purge operation is taking place, the controller 150 may provide an output to the audio/visual device 158.

It will also be appreciated that step S108 and S110 may take place prior to S106. However it may be considered unexpected by the operator if the engine cranks without a cranking demand.

Once the purge is complete (or if no purge was required), the process then moves on to step S112. In this step, the controller signals the firing of each of the coils 23 to check for the generation of a spark, without opening the injectors 22 to provide hydrogen into the cylinders 5. In this embodiment the coils 23 are “smart” and provide a feedback to controller 150 based on the coil discharge time, which indicates if a spark is generated, or fouling of the spark plugs 21 by water or oil impairs their operation (no spark or a weak spark). This step may also require cranking of the engine, if the firing of the coils 23 requires this, or may be possible by firing all coils simultaneously or faster than is possible with the engine 1 being cranked.

If the controller 150 determines that any of the spark plugs 21 are wet from the feedback, at step S114 it then undertakes a spark plug 21 drying operation. In this operation, the controller signals the firing of the coils 23 and cranking of the engine 1 without the introduction of the hydrogen fuel. The current through the spark plugs combined with a flow of air through the cylinder from the cranking promotes the removal of water from the spark plugs 21. In other embodiments the controller 150 may only signal firing of the coils 23 or only the cranking to promote drying.

To indicate to an operator that the spark plug drying operation is taking place, the controller 150 may provide an output to the audio/visual device 158.

The operation continues for a predetermined time period, predetermined number of crank revolutions or until the diagnostic feedback indicates that all plugs are sparking reliably. An upper time or revolution limit is placed on the operation so as to avoid the engine battery being depleted. If this limit is reached, and at step S116 sparking is not detected on all spark plugs 21, the controller logs a fault code at step S118, prevents engine 1 start, and may display a suitable error message via the audio/visual output 158.

If during the spark plug drying operation, combustion is detected in the engine 1, for example via an increase in engine speed above crank rpm, as detected by the crank speed sensor 25, this is indicative of the unexpected presence of fuel. In this situation the drying operation is aborted.

At step S120, if the operation succeeds in drying the spark plugs 21, the controller initiates the supply of fuel via the injectors 22 in order that the engine 1 may run normally.

However, the coil 23 monitoring is continued. If combustion is not detected on all cylinders 5 at step S122—e.g., the engine is only running on three cylinders-the controller 150 signals the injector 22 for that cylinder to cease supplying fuel for a predetermined period at step S124 whilst allowing the remaining cylinders to run. This prevents uncombusted hydrogen from being exhausted from the engine 1, which is undesirable from environmental and safety perspectives. However, as with the drying operation of step S114, the airflow and continued sparking may dry the spark plug 21. If the coil diagnostics indicates at step S126 sparking is detected, the fuel supply to that cylinder is recommenced at step S120. The is achieved as the engine 1 is running in this embodiment, or, in another embodiment, by requiring an operator to stop and re-start the engine 1.

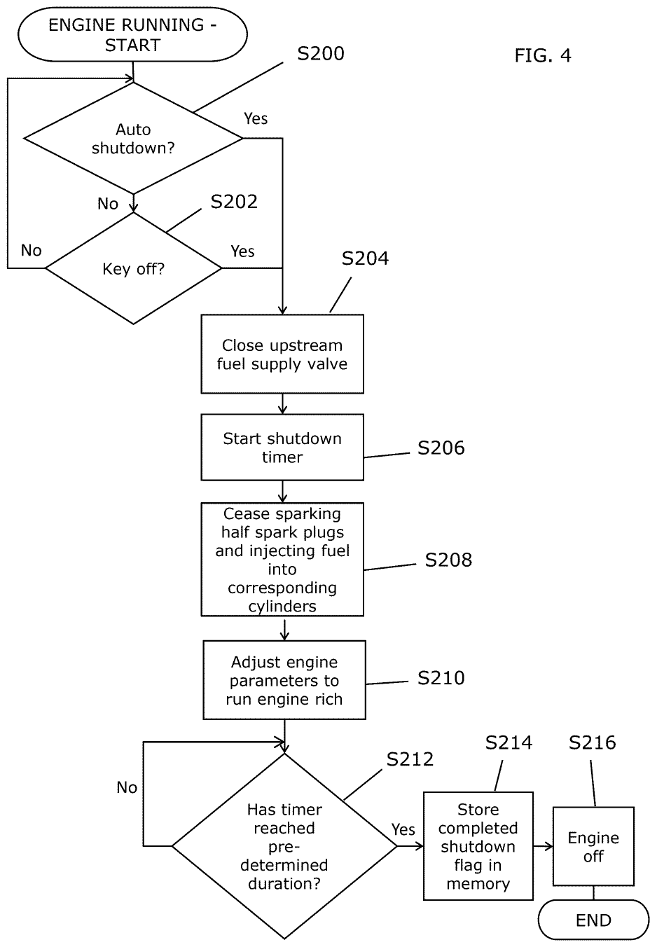

If after the predetermined period, for example in a range of 30-180 seconds, no sparking is detected at step S126 the controller signals the shutdown of the engine (in accordance with the process set out in FIG. 4 and described below) and also logs a fault code for diagnostic purposes at step S128. Such a command prevents extended running on limited cylinders compromising engine operation and/or durability.

If, at step S122, combustion is detected on all cylinders 5, the start process is deemed successful and complete, allowing the engine 1 to run normally.

In a variant of steps S116, S120 and S122, if, at step S116, the drying operation times out and sparking on, say three of four cylinders 5 is detected, the controller may move to step S120 rather than S118 and supply fuel to only the working cylinders and monitor for the drying and sparking of the spark plug 21 of the remaining cylinder 5. This may minimize operator inconvenience as it may avoid the need for service personnel to attend the engine 1 for repair.

Referring now to FIG. 4, an engine shutdown process is described. The process is configured to fully or partially empty the common fuel rail 52 of pressurized hydrogen fuel prior to a complete stop of the engine 1. This minimizes the risk of the hydrogen leaking past the fuel injector nozzles whilst the engine 1 is off, dwelling in the cylinders 5, intake manifold 11 and intake runners 16, and then being ignited in an uncontrolled way when the engine restarts, which may cause damage to the engine.

The process starts with the engine 1 running, and at step S200 the controller monitors engine idle time, and if the engine has idled for a predetermined period (such as five minutes, for example) determines that auto engine shutdown is to be initiated as a fuel saving measure, and moves to step S204. If the idling threshold has not been reached, the controller then monitors for a key-off signal from the engine start device 156 at step S202. If no key-off request is detected the process returns to the start. If the key-off request is detected, the process also moves to step S204.

At step S204, the controller 150 signals closing of the fuel supply valve 54, blocking the flow of fuel into the common fuel rail 52, before starting a shutdown timer at step S206 and signaling ceasing sparking half of the spark plugs 21 and ceasing injecting fuel into the cylinders 5 corresponding to the non-firing spark plugs at step S208. At step S210 the controller 150 then adjusts the engine operating parameters to run the engine rich (i.e., with a higher fuel-to-air ratio) by extending the fuel injection window on the running cylinders 5.

Rich running causes the hydrogen to be burnt more rapidly, therefore minimizing the extended running period, which is desirable from an operator acceptance point of view. However, in hydrogen fueled engines, rich running has been associated with a greater risk of the combustion product (water) wetting the spark plugs 21. Thus, the preceding step of shutting fuel and combustion from two cylinders reduces the risk of those cylinders having wet spark plugs 21, which means a subsequent engine re-start is likely to be more successful. The increased fuel use from rich running more than offsets the reduced fuel consumption from shutting down half the cylinders.

In a variant of steps S208 and S210 that may be employed for direct injection engines, in particular, a standard fuel mix (as determined by a map or look-up table normally employed by the engine ECU) may be provided for some cylinders and rich running for other cylinders, to a similar end of reducing the wetting risk on some cylinder to aid engine re-start.

In other embodiments one or both of steps S208 and S210 may be omitted.

At step S212, the controller 150 determines if the shutdown timer has reached its predetermined duration of extended running. This duration is set based on a calculation of the period required for the number of engine revolutions to displace the volume of hydrogen that is held within the common fuel rail 52 at its operating pressure, when expanded to atmospheric pressure. Typically this may equate to a time of approximately 1-3 seconds. In other embodiments, the controller may instead signal the spark plugs 21 to fire and injectors 22 to operate for a predetermined number of crank revolutions required to empty the common fuel rail 52.

In other embodiments the controller 150 may monitor the fuel rail 52 pressure via r pressure sensor 53. Once this has reduced to a threshold pressure at which the remaining hydrogen fuel would not represent a damage risk to the engine if it were to leak past the injectors (e.g., less than 2.5 bar, optionally less than 2 bar down to at or near atmospheric pressure). If a positive pressure is maintained this may reduce the risk of debris entering the common fuel rail 52.

Then at step S214 the controller 150 stores a completed shutdown flag in the memory 154 to be used at step S108 of the engine start process of FIG. 3. If the engine stops abnormally, e.g., due to a stall or an emergency stop (via an engine isolator switch), this flag will not be set, or a different flag set, so in the start process the controller 150 instead runs the purge operation of step S110.

At step S216 the controller 150 then signals closing of the injectors 22 and the coils 23 to cease sparking to shut down the engine 1, and the process is complete.

If the engine is unable to be started and a service visit is required, the service operative may use a service tool to run a drying operation or the fault code may advise a removal and physical drying of any affected spark plugs 21 as required.

The one or more embodiments are described above by way of example only and it will be appreciated that the variations are possible without departing from the scope of protection afforded by the appended claims. For example, if the engine is equipped with an electric starter generator (e.g., is a hybrid engine) this may be utilized to crank the engine to purge the fuel.

1. An engine shutdown system for a hydrogen fueled internal combustion engine, the system comprising:
a controller;
wherein upon receipt of a standard engine shutdown command, the controller is configured to instruct the clearing of excess hydrogen fuel from a fuel delivery system of the engine as part of an engine shutdown process.

2. The engine shutdown system of claim 1 wherein the system further comprises:
at least one fuel ignition device in communication with the controller;
a fuel delivery system in communication with the controller;
wherein the system is configured such that upon receipt of an engine shutdown command, the controller is configured to instruct the ceasing of the supply of hydrogen fuel into the fuel delivery system and is configured to allow extended operation of the engine beyond the ceasing of the supply of hydrogen so as to clear excess hydrogen held within the fuel delivery system by combustion.

3. The engine shutdown system of claim 2, wherein the controller is configured to instruct a reduction in lambda during the extended operation of the engine, and optionally, (i) wherein the reduction in lambda is between 1.1 and 1.7, and/or (ii) wherein lambda prior to the engine shutdown process beginning is between 1.8 and 4.5.

4. (canceled)

5. (canceled)

6. The engine shutdown system of claim 3, wherein the reduction in lambda is provided by increasing the duration an injector of the fuel delivery system is injecting hydrogen, and, optionally, wherein the duration the injector is injecting hydrogen is between 6 ms and 35 ms.

7. (canceled)

8. The engine shutdown system of claim 1, wherein the engine timing is adjusted during the extended operation period, such that the torque is reduced, and, optionally, wherein spark ignition timing prior to the engine shutdown process beginning is optionally +10 degrees and −20 degrees in relation to top dead center and the spark ignition timing following the engine shutdown process beginning is optionally between 0 and −2 degrees in relation to top dead center.

9. (canceled)

10. The engine shutdown system of claim 2, wherein the system comprises a plurality of fuel ignition devices corresponding to a plurality of engine cylinders and wherein the controller is configured to instruct ceasing of the sparking of one of the fuel ignition devices for at least part of the extended operation of the engine.

11. The engine shutdown system of claim 2, wherein the controller permits operation for a pre-determined period or for a predetermined number of engine revolutions and/or wherein the controller monitors a fuel pressure in the fuel delivery system and permits operation until a predetermined pressure of the fuel is reached.

12. The engine shutdown system of claim 1, wherein the controller is configured to log in a memory once the clearing operation is completed.

13. The engine shutdown system of claim 2, wherein the fuel delivery system comprises a fuel injector in fluid communication with a common fuel rail and the controller instructs a closing of a supply of fuel upstream of the common fuel rail during the extended operation.

14. (canceled)

15. (canceled)

16. (canceled)

17. (canceled)

18. (canceled)

19. An engine control system for a hydrogen fueled internal combustion engine, the system comprising:
a controller;
wherein, the controller is configured to confirm if excess hydrogen has been cleared from the engine prior to a start of the engine, and if clearing of excess hydrogen cannot be confirmed, the controller is configured to instruct a hydrogen purge operation of the engine prior to permitting a restart of the engine.

20. The engine control system of claim 19, wherein upon receipt of a standard engine shutdown command, the controller is configured to instruct the clearing of excess hydrogen from a fuel delivery system of the engine as part of an engine shutdown process.

21. The engine control system of claim 19, further comprising at least one fuel ignition device in communication with the controller; and a hydrogen fuel delivery system in communication with the controller; wherein the system is configured such that upon receipt of an engine shutdown command the controller is configured to instruct the ceasing of the supply of fuel into the fuel delivery system and is configured to allow an extended operation of the engine beyond the ceasing of the supply of fuel so as to combust fuel held within the fuel delivery system.

22. The engine control system of claim 19, wherein the controller is configured to instruct a reduction in lambda during the extended operation of the engine.

23. The engine control system of claim 20, wherein the system comprises a plurality of fuel ignition devices corresponding to a plurality of engine cylinders and wherein the controller is configured to instruct ceasing of the sparking of one of the fuel ignition devices for at least part of the extended operation of the engine.

24. The engine control system of claim 19, wherein the controller is configured to log in a memory once extended operation is completed.

25. The engine control system of claim 20, wherein the fuel delivery system comprises a fuel injector in fluid communication with a common fuel rail and the controller instructs a closing of a supply of fuel upstream of the common fuel rail during the extended operation.

26. The engine control system of claim 20, wherein the controller is configured to instruct the cranking of the engine without instructing the sparking of the fuel ignition device so as to purge the engine of hydrogen prior to permitting a start of the engine, and, optionally, wherein the controller is further configured to instruct the hydrogen fuel delivery system not to supply fuel during the purge operation.

27. (canceled)

28. The engine control system of claim 20, wherein the controller is configured to instruct the purge operation for a predetermined time or for a predetermined number of engine revolutions

29. The engine control system of claim 20, wherein the controller is further configured to instruct sparking of the fuel ignition device without instructing the supply of fuel to commence and is configured to monitor an output of the fuel ignition device for a signal indicative of the generation of a spark prior to permitting a start of the engine.

30. A hydrogen fueled internal combustion engine comprising an engine shutdown system according to claim 1.

31. (canceled)

32. (canceled)
